(19) United States
(12) Patent Application Publication
(10) Pub. No.: US 2017/0280523 A1
(43) Pub. Date: Sep. 28, 2017

(54) SINGLE-STAGE MULTI-STRING LED DRIVER WITH DIMMING

(71) Applicant: NATIONAL UNIVERSITY OF SINGAPORE, Singapore (SG)

(72) Inventors: Ramprakash KATHIRESAN, Singapore (SG); Pritam DAS, Singapore (SG); Thomas Guenter REINDL, Singapore (SG); Parthiban THIYAGARAJAN, Singapore (SG)

(73) Assignee: NATIONAL UNIVERSITY OF SINGAPORE, Singapore (SG)

(21) Appl. No.: 15/504,978

(22) PCT Filed: Aug. 18, 2015
(86) PCT No.: PCT/SG2015/050261

§ 371 Date: Feb. 17, 2017

Related U.S. Application Data
(60) Provisional application No. 62/038,522, filed on Aug. 18, 2014.

(51) Int. Cl. H05B 33/08; H02M 3/335; H05B 37/02

(52) U.S. Cl. CPC H05B 33/0815; H05B 33/0827; H05B 33/0848; H05B 37/02; H02M 3/33561

(57) ABSTRACT

A driver circuit for light emitting diodes (LEDs) and a driving method for LEDs. The driver circuit comprises a single stage DC-DC converter with multiple output channels, the converter comprising one set of switches on a primary side of the converter, a rectifier and voltage multiplier component at the secondary side; and a dimming control component configured to control the respective switches on the primary side of the converter for controlling an output current in the multiple output channels.

### FIELD OF INVENTION

The present invention relates broadly to a single-stage multi-string LED driver with dimming capability and to a driving method for LEDs.

### BACKGROUND

In recent years, the technical maturity and energy efficiency of light-emitting diodes (LED) made them the preferred technology to achieve energy savings in the illumination sector. Though several advantages make LED superior to other lighting technologies, one key reason for a lack of consumer interest in LED lighting is its higher upfront cost, which is currently about five times that of compact fluorescent (CFL) light sources of same luminescence, despite the fact that the lifecycle cost are a currently about a factor of 2 lower due to the about 10-fold longer lifetime. Luminescence in LEDs is dependent on their currents and hence sophisticated current controlling drivers are required to operate LEDs for lighting applications.

For efficient and reliable operation, LED clusters are typically aligned in a in row-column layout, where sets of LEDs are connected in series forming a string and several strings are connected in parallel, depending on voltage and current specifications and/or limitations. For uniform illumination, every string requires an equal DC current to operate, irrespective of any fault or mis-match in one or more LEDs in that string, hence active current control in every string needs to be provided, which requires active semiconductors, passive components, sensors and complex controllers for each string of LEDs. Commercial drivers presently available thus typically have individual control loops 101-103 per LED string along with active switching devices, active and passive devices (as shown in FIG. 1) and are hence costly, complex, relatively bulky and typically account for 50% of the total cost of a commercial LED lamp. Illumination variation due to improper current regulation in series-parallel configuration of LEDs can also lead to pre-mature failure due to negative temperature co-efficient property of LEDs.

LED drivers typically also require input AC-DC converters with power factor correction (PFC) to prevent corruption of power quality of the electric power grid through the currents drawn by multiples of these electronic drivers. Accordingly, current LED drivers in general consist of:
One AC-DC boost converter with one controller for input PFC/AC-DC conversion, followed by
One isolated high frequency DC-DC converter with one controller feeding “N” current controllers; and:
“N” numbers of DC-DC non-isolated converters at the secondary side of the isolated DC-DC converter, with “N” controllers and “N” sensors for controlling the currents in each string

As such, conventional AC/DC LED drivers typically have “2+N” converters and “2+N” controllers, which is the primary reason for the high cost of LED drivers.

Embodiments of the present invention provide multi-string led driver with dimming capabilitiy that operates in a single stage and seeks to address at least one of the above problems.

### SUMMARY

In accordance with a first aspect of the present invention there is provided a driver circuit for light emitting diodes (LEDs) comprising a single stage DC-DC converter with multiple output channels, the converter comprising one set of switches on a primary side of the converter, a rectifier and voltage multiplier component at the secondary side; and a dimming control component configured to control the respective switches on the primary side of the converter for controlling an output current in the multiple output channels.

In accordance with a second aspect of the present invention there is provided a driving method for LEDs, the method comprising using a single stage DC-DC converter with multiple output channels, the converter comprising one set of switches on a primary side of the converter, a rectifier and voltage multiplier component at the secondary side; and controlling the respective switches on the primary side of the converter for controlling an output current in the multiple output channels for dimming.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows an existing LED driver with individual control loops per LED string along with active switching devices, active and passive devices.

FIG. 2 shows a general block diagram of a single stage multi-channel constant current converter with controller for LED lighting applications.

FIG. 3 shows a schematic circuit diagram of one example embodiment of the converter along with one example embodiment of the controller.

FIG. 4 shows the waveform during converter operation as per the controller shown in FIG. 3.

FIG. 5 shows a schematic circuit diagram of another example embodiment of the controller along with a general block diagram of a single stage multi-channel constant current converter.

FIG. 6 shows a schematic circuit diagram of the controller according to another embodiment.

FIG. 7 shows a schematic circuit diagram of an open-loop example embodiment of the controller.

FIG. 8 shows a schematic circuit diagram of another example embodiment of the controller.

FIG. 9 shows an example embodiment of an LED channel with failure protection.

FIG. 10 shows another example embodiment of an LED channel with failure protection.

FIG. 11 shows a schematic circuit diagram of another example embodiment of the converter.

FIG. 12 shows a general block diagram of another example embodiment of the converter.

FIG. 13 shows a flow chart illustrating a driving method for light emitting diodes LEDs according to an example embodiment.

### DETAILED DESCRIPTION

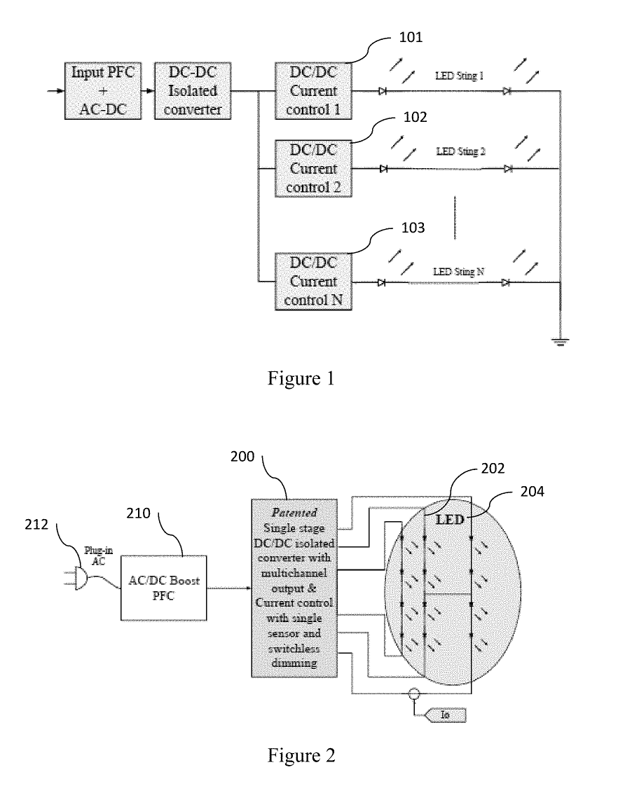

Example embodiments described herein provide a single stage multi-channel driver with dimming capability for LED lighting applications. In the general block diagram as shown in FIG. 2, a converter with controller 200 for application in LED lighting is provided with single sensor based sensing and external dimming without additional secondary-side switches. This design advantageously helps in reduction in cost due to lesser stages being required and efficiency improvements compared to existing designs. The size, volume, and weight are also preferably reduced or minimized without compromise in reliability and can preferably be assured for 100,000 hours operation to match the lifetime of LEDs. In FIG. 2, the converter with controller 200 is interconnected to parallel sets e.g. 202, 204 of LEDs, the LEDs of each set 202, 204 being connected in series. A single control loop signal from one of the sets, say 202 is fed into the converter with controller 200. An AC/DC boost power factor correction converter 210 is coupled to the converter with controller 200, and is in turn connectable to a mains supply (not shown) via AC plug 212.

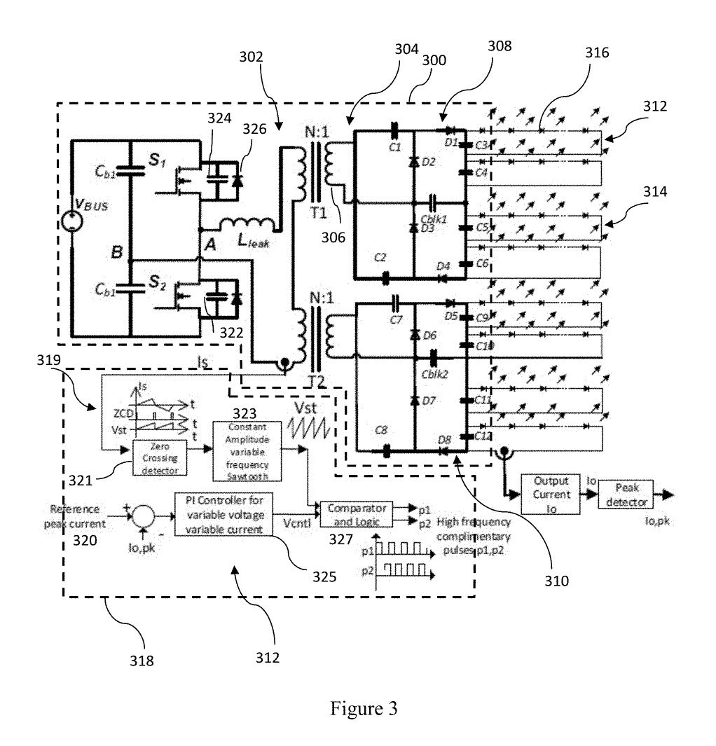

FIG. 3 shows the circuit diagram of an embodiment of the converter 300 along with an embodiment of the controller 318 for the converter with controller 200 of FIG. 2. The input DC voltage from the AC/DC converter 210 (see FIG. 2) is represented as V_{BUS} (or) Vdc followed by a split DC_{BUS} (midpoint B) formed by a series combination of capacitors Cb1 and Cb2. The devices S1 and S2 (respective power MOSFETs in this example embodiment) and high frequency isolation transformers T1 and T2 with turns ratio of N:1 and leakage inductor Lₗₑₐₖ forms the primary side 302 of a single stage DC-DC converter 300. On the secondary side 304 there are rectifier diodes D1˜D8, DC blocking capacitors Cblk1, Cblk2 and the output capacitive filters C1˜C12. The DC blocking capacitors Cblk1 are placed in series with the transformer secondary e.g. 306. The use of rectifier and voltage multiplier components, here in the form of symmetric voltage quadrupler rectifiers 308, 310, advantageously leads to reduction of the number of high frequency transformers for a given number of total LED channels or sets e.g. 312, 314, and also preferably reduces high frequency ripple current in the LEDs e.g. 316.

The gain of the DC-DC converter 300 is determined by its switching frequency, as will be appreciated by a person skilled in the art. A controller circuit 318 is designed to modify the switching frequency for that purpose. As the gain of the DC-DC converter 300 is varied, it alters the output current of the converter 300, i.e. the current passing through the LEDs e.g. 316 varies giving different luminescence/brightness. The controller circuit 318 accepts a reference value (reference peak current 320) and a feedback value (lo, pk) to set the switching frequency (pulses p1, p2) appropriately. The Self Sustained Oscillation Control (SSOC) controller 318 consists of a ramp generator part 319 and a proportional integral (PI) controller part 319. A zero crossing detector (ZCD) 321 is used to detect the zero cross-over of the series current in the primary side 302. This ZCD signal is used as a resetting the amplitude of a sawtooth waveform generator 323. In parallel, the error between the reference and feedback signals is minimized using a PI (or) proportional integral derivative (PID) controller 325 and the control signal thus generated (‘Vcntrl’) is compared with the sawtooth generated ‘Vst’ to generate the high frequency complimentary pulses ‘p1’ and ‘p2’ with dead-band logic in a comparator and logic 327 to operate the switches S1 and S2 respectively. Varying reference and feedback signals thus in-turn determine the variable frequency of the converter operation and the gain henceforth.

Modes of Operation:

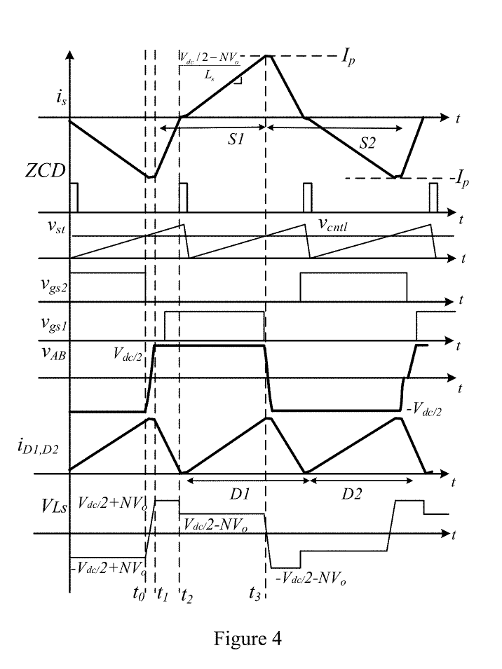

In order to preferably take full advantage of the properties of the LED driver in an example embodiment, a control methodology—referred to herein also as the Self Sustained Oscillation Control (SSOC)—is implemented for the load-side (here LED in this example application) peak current mode control in non-resonant isolated DC-DC converter 300. The different modes of operation are as follows in an example embodiment, with reference to FIGS. 3 and 4 (FIG. 4 shows the waveform of converter operation according to the operation modes described):
MODE I (t0≦t≦t1): At t0, S2 is turned off by reducing its gate source voltage V_{GS2} to zero at t0. This occurs when the controller voltage Vcntrl becomes less than the amplitude of the variable frequency constant amplitude sawtooth signal Vst. The output capacitor 324 of S1 is discharging and output capacitor 322 of S2 is charging up with the current provided by the series inductor Lₗₑₐₖ in the primary side 302. This mode ends with the complete charging and discharging of output capacitor 322 and 324 to and from V_{DC} respectively. At the end of this mode I the body diode 326 of the device S1 conducts. The duration of this mode is advantageously small enough to consider the current in the series inductor, Lₗₑₐₖ, in the primary side 302 to be constant so that Ileak(t0)≈Ileak(t1).
MODE II (t1≦t≦t2): This mode II commences with the conduction of the body diode 326 of the device S1. A net voltage (V_{DD}/2+NV₀), where N is the number of transformer turns and V₀ is the output voltage at the secondary side 304, is incident across the series inductor (primary side 302) so that the current through the inductor ramps up with a slope of:

$$\frac{d ( {i}_{lk} )}{dt} = \frac{( \frac{{V}_{DC}}{2} + {NV}_{o} )}{{L}_{leak}}$$

This mode II ends with the current in the inductor (primary side 302) Lₗₑₐₖ raisng to zero. It should be noted that at some time during this mode II the device S1 can be turned ON with loss-less Zero Voltage Switching (ZVS) by applying a positive gate source voltage V_{GS1}, which advantageously eliminates the switching power.
MODE III (t2≦t≦t3): The zero crossing detector 321 output goes high momentarily at t2 which resets Vst to zero amplitude following which Lₗₑₐₖ starts ramping up again with a different slope of:

$$\frac{d ( {i}_{lk} )}{dt} = \frac{( \frac{{V}_{DC}}{2} + {NV}_{o} )}{{L}_{leak}}$$

At t2 the current in the primary side 302 inductor Lₗₑₐₖ begins to ramp up to Ipeak. This mode III ends with turning OFF of the device S1 at time t3 which also marks the end of half a switching cycle when the controller voltage Vcntrl becomes again less than the amplitude of the variable frequency constant amplitude sawtooth signal Vst. At the end of this cycle a mode corresponding to Mode I commences in an opposite fashion.

This repeated action in the example embodiments advantageously helps in transferring the power from the DC input V_{BUS} into high frequency AC. In the secondary side 304 of the transformer, quadrupler (4× output) rectifiers 308, 310 are implemented to rectify the high frequency AC to DC power from which the LEDs e.g. 316 are operated. During Modes I and II, output rectifier diodes and capacitor D2-D1-D4-C2 and D6-D5-D8-C8 will be conducting. These diodes D2-D1-D4 and D6-D5-D8 may turn off with loss-less zero current switching (ZCS) at time t2, which advantageously reduces any loss from diode reverse recovery.

Notably, in the example embodiment all high-frequency semiconductor switching (about 150 kHz in an example implementation) undergoes soft switching either by zero-voltage switching for the MOSFETs or by zero-current switching of output diodes for a wide load range. Soft switching operation of these semiconductor components advantageously leads to highly efficient and long-term reliable operation of the converter. It is believed by the inventors that having a lesser number of controllers and control loops for controlling a power converter is also expected to be preferred in the industry since redundancy in control loops can give rise to interaction amongst controllers resulting in a sequential catastrophic failure. Also, the converter embodiments advantageously operate with clamped output diode voltage and with only a capacitive filter eliminating the requirement of LC filter.

In a modification of the above embodiment, instead of load side peak current, also the average of the load side current Io can be used as a feedback control parameter for the controller circuit 318.

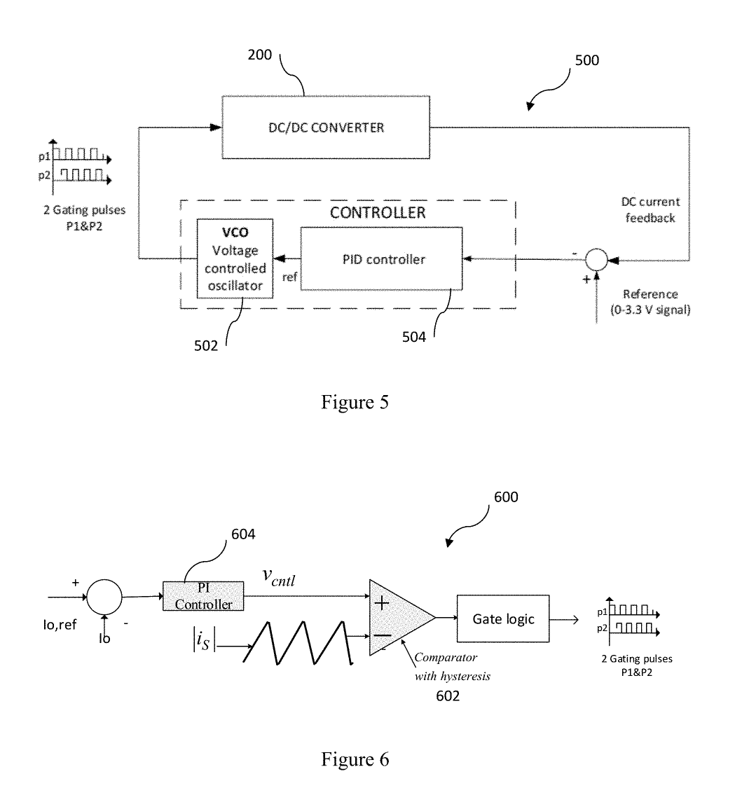

In another embodiment shown in FIG. 5, a voltage controlled oscillator is implemented by way of a controller circuit 500 to vary the switching frequency/gain of the DC-DC converter 200. A voltage control oscillator 502 outputs variable frequency based on an input voltage. Here, the PI (or) PID controller 504 reference signal sets the aforementioned variable frequency voltage in the direction to minimize the error between the reference and feedback signals. It is again to be remembered that this variable voltage can vary the frequency of operation and hence the gain of the converter.

In another embodiment shown in FIG. 6, an input side peak current mode control (cycle by cycle control) is implemented by way of a controller circuit 600 to vary the switching frequency/gain of the DC-DC converter 200 (FIG. 2). Here, the comparator 602 advantageously helps in toggling the state of the switches S1 and S2 (see FIG. 2) at the set point. The set point hence determines the frequency of toggling/frequency or gain of the DC-DC converter. To note, the set point is determined by the PI (or) PID controller 604 which accepts the error in the reference (Io, ref) and feedback (Io) signals as its input. This method advantageously controls the LED average currents without the requirement of additional slope compensation technique.

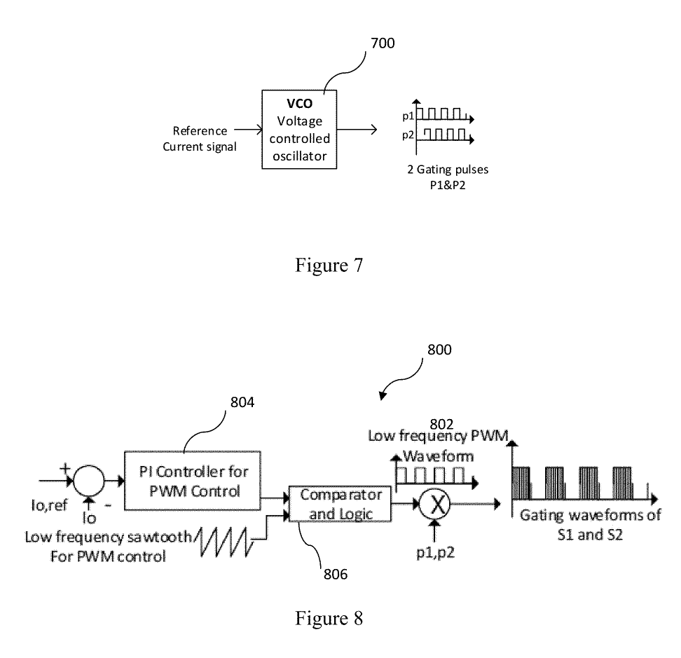

The DC-DC converter 200 topology and operation principle (variable gain) as described above with reference to FIG. 2 can be used with the different embodiments of the control circuit/methods described (i.e. the different circuits/methods of actuating the switches S1 and S2 differs). The above described embodiments are closed-loop implementations where the feedback signal and a PI (or) PID controller is present. However, an open-loop implementation with a set reference alone can also be used in different embodiments. In the open-loop implementation, any variable frequency gating pulses is used to operate the switches. In one example shown in FIG. 7, the output of VCO 700 which outputs different frequency pulses based on the reference provided is used. In this case, any faults are not compensated as no information is reflected in the switching frequency.

In the described embodiments, CCR (constant current reduction) mode of dimming can be implemented. Dimming of LEDs can also be performed by PWM (Pulse width modulated control). PWM mode control has lesser chromatic shift compared to CCR mode. In PWM mode example embodiments, the pulses p1 and p2 are multiplexed with a low frequency PWM waveform 802 as shown in the schematic circuit diagram 800 in FIG. 8 and now gating signals s1 and s2 are used to operate the corresponding switches S1 and S2 of the DC-DC converter 200 (compare FIG. 2). The error between the reference (Io,ref) and feedback (Io) signals is minimized using a PI (or) PID controller 804 and the control signal thus generated is compared with a low frequency sawtooth to generate the low frequency PWM 802 with dead-band logic in a comparator and logic 806. The low frequency PWM 802 is preferably a variable ON-time (or) variable duty and constant frequency. The change in the ON time translates to variable brightness of the LED due to varying current in the string. The pulses p1 and p2 used to multiplex can be from any of the afore-mentioned embodiments of the controller. Due to the robustness of the topology, such pattern of gating pulses does not cause the converter to tend away from stability and a robust operation is advantageously observed.

All of the described embodiments exhibit global asymptotic stability which advantageously operates without any oscillations and overshoots in the LED channel while in both CCR and PWM modes of dimming. This is preferably achieved due to the absence of any oscillatory components in the non-resonant tank which gives rise to a dominant RC pole (due to non-resonant components and purely capacitive output filter) that gives inherent damping. This stable performance preferably eliminates the requirement of secondary control devices and additional control methods such as state trajectory control for executing PWM mode of dimming.

Protection of LEDs:

Returning to FIG. 3, the DC blocking capacitor Cblk1 and Cblk2 provided on the secondary side of the transformer advantageously give rise to the following protective feature in a multi-channel LED driver according to various embodiments:

If LEDs are shorted in one or more channels/sets e.g. 312, 314, or there is a mismatch in the net forward voltages of the LEDs in different channels/sets e.g. 312, 314 at the secondary side 304 of the transformer, then a DC voltage equal to the difference of the voltages at the voltage multiplier output to the LED strings e.g. 312, 314 will give rise to a DC offset current in the secondary side 304 of the transformer. The presence of the DC blocking capacitors Cblk1 and Cblk2 placed in series with the secondary side 304 windings preferably prevents the flow of this DC offset current. This advantageously results in a DC voltage equal to the net DC offset voltage to appear across the DC blocking capacitor Cblk1 and Cblk2. This simple mechanism basically blurs or masks the LED failure from the primary side 302 of the DC-DC converter 300, so that the main converter 300 essentially always finds an apparent constant voltage being maintained at the transformer secondary side 304, irrespective of an LED failure, and continues to deliver the same amount of average current at the LED strings e.g. 312, 314. This protective feature against LED short failure advantageously allows valid resistive sensing of LED channel current even during LED failures in the sensing channel.

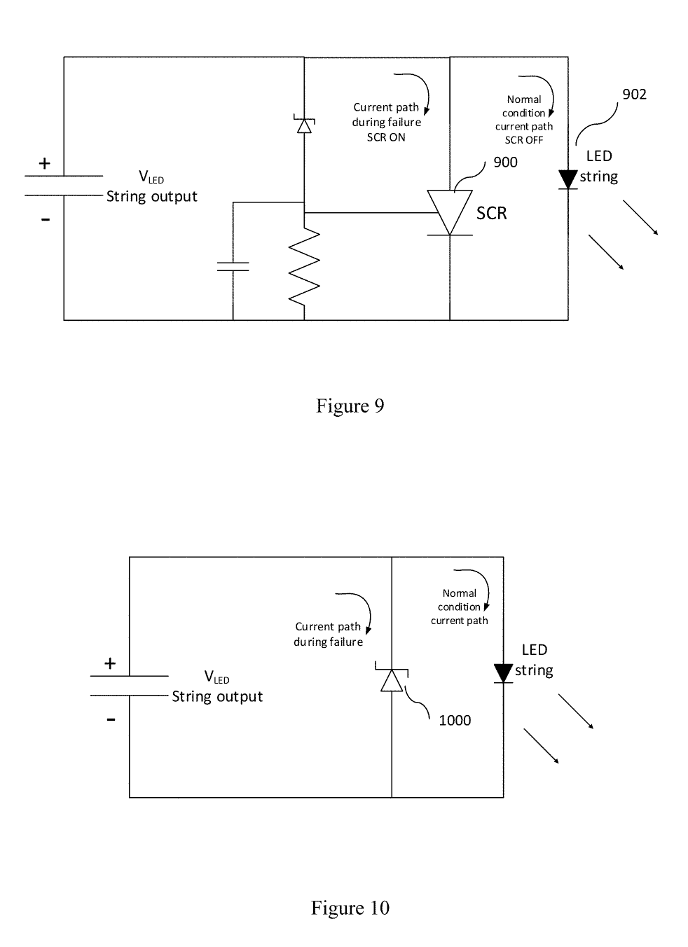

LED open failure is protected in an example embodiment by putting parallel silicon control rectifier (SCR) crowbar circuits across all channels/sets as in FIG. 9. This protection mechanism advantageously converts an open-circuit fault condition to a short circuit fault condition and accordingly behaves as described above for the LED shorted failure. During normal operation, the SCR 900 is open and the current normally flows through the LED string 902. During LED open circuit failure, the voltage at that particular channel builds up with triggers the SCR 900 via its gate and it starts conducting. This helps in diverting the current flow via the SCR 900 and prevents failure of any components associated and other strings. In another embodiment as shown in FIG. 10, Zener diodes 1000 of sufficient power dissipation capacity is placed across the LED channels. Upon open circuit fault condition, the Zener diode 1000 starts conducting upon attaining the Zener voltage and the current path is hence diverted through it.

These protection mechanisms advantageously give an inherent open and short circuit capability to the converter in example embodiments. The extent of open or short circuit protection capability is substantially 100%.

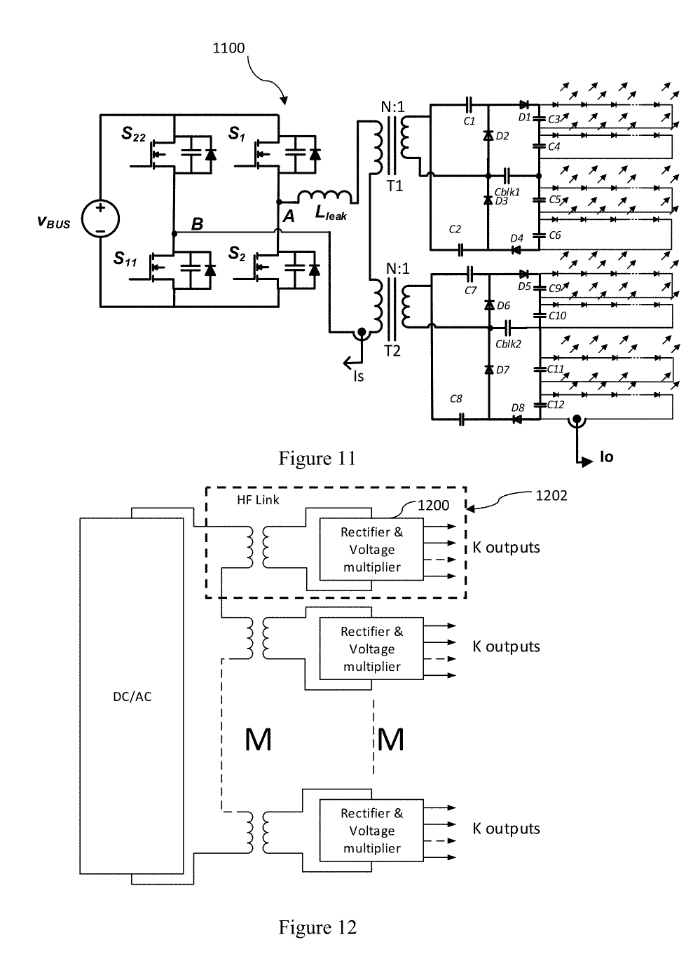

In another embodiment of the converter, instead of a split bus capacitor and a half-bridge topology with two switches, four switches can be utilized for the same purpose for high power applications and further increase of the power density of the converter. In this embodiment of the converter 1100 as in FIG. 11, the gating pulses p1 and p2 from any of the embodiments of the controller described above will now assist in controlling a pair of switches (S1, S11) and (S2, S22) respectively. The other operation and principle remains the same. While in the embodiments of the controller in FIG. 3 and FIG. 11, a symmetric voltage quadrupler type of voltage multiplier is preferably used, other forms of voltage multipliers 1200 can also be used in different embodiment giving ‘K’ outputs. Also to be noted is that, any number of ‘M’ transformer and voltage multiplier pairs 1202 can be used to advantageously power multiple strings of LEDs.

In one embodiment, a driver circuit for light emitting diodes (LEDs) comprises a single stage DC-DC converter with multiple output channels, the converter comprising one set of switches on a primary side of the converter, a rectifier and voltage multiplier component at the secondary side; and a dimming control component configured to control the respective switches on the primary side of the converter for controlling an output current in the multiple output channels.

The converter may be configured for non-resonant operation.

The dimming component may be configured to receive a first reference current signal and to generate control pulses based on the reference current signal for controlling the respective switches on the primary side of the converter.

The dimming component may be configured to receive the first reference current signal and a feedback current signal representative of the output current, and to generate the control pulses based on the reference current signal and the feedback current signal for controlling the respective switches on the primary side of the converter. The dimming component may comprise a proportional integral (PI) controller or a proportional integral derivative (PID) controller for minimizing a difference between the first reference current signal and the feedback current signal through the generating of the control pulses. The dimming component may comprise a comparator element for generating the control pulses based on a control signal from the PI or PID controller and a saw-tooth waveform. The dimming component may be configured to generate a zero-crossing signal by detecting zero-crossing in a primary current on the primary side of the converter and to reset a saw-tooth signal based on the zero-crossing signal to generate the saw-tooth waveform. The dimming component may be configured for peak current detection on the primary side of the converter to generate the saw-tooth waveform. The dimming component may comprise a voltage controlled oscillator (VCO) configured to generate the control pulses based on a control signal from the PI or PID controller.

The dimming component may be configured for open loop generation of the control pulses. The dimming component may comprise a voltage controlled oscillator (VCO) configured to generate the control pulses based on the first reference signal.

The dimming component may be configured for pulse width modulation (PWM) of the control pulses. The dimming component may be configured for multiplexing the control pulses with a low frequency PWM waveform. The dimming component may comprise a further PI or PID controller for minimizing a difference between a PWM reference current signal and a PWM feedback current signal representative of the output current in the multiple output channels through the PWM of the control pulses. The dimming component may comprise a further comparator element for PWM of the control pulses based on a control signal from the further PI or PID controller and a saw-tooth carrier signal.

The circuit may further comprise a component configured for preventing a DC-offset current in the secondary side of the converter. The isolation component may comprise DC blocking capacitors disposed in series with respective secondary side windings of a transformer of the converter. Each blocking capacitor may be disposed such that a DC voltage equal to the DC-offset is applied across said each blocking capacitor in case an LED in the output channel coupled to said each blocking capacitor is shorted.

The circuit may comprise a rectifier crowbar circuit disposed in each output channel for diverting current flow in said each output channel through a rectifier of the rectifier crowbar circuit in case of open failure of an LED in said each output channel. The rectifier may comprise a silicon control rectifier (SCR).

The circuit may comprise a Zener diode disposed in each output channel for diverting current flow in said each output channel through the Zener diode in case of open failure of an LED in said each output channel.

A galvanic isolation may be provided between the primary and secondary sides of the converter.

Primary side devices of the converter may undergo zero voltage switching.

Secondary side output diodes of the converter may undergo zero current switching.

A filter at each output channel may comprise only a capacitive filter.

The converter may operate with global asymptotic stability for both CCR and PWM modes of dimming.

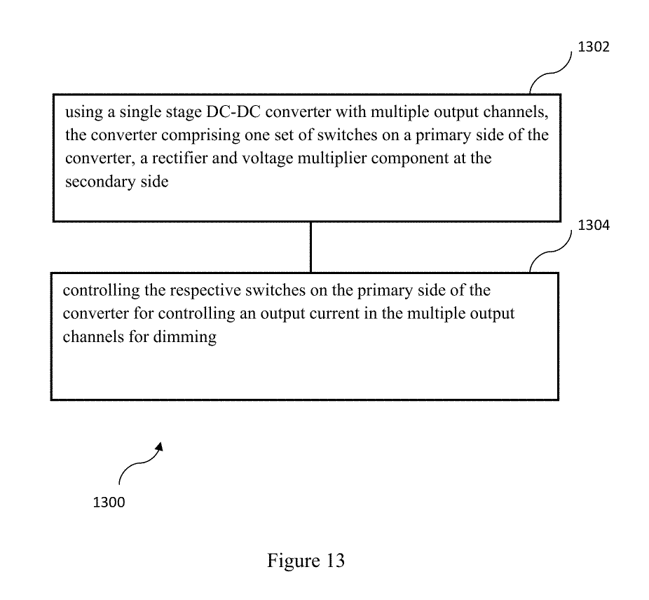

FIG. 13 shows a flowchart 1300 illustrating a driving method for light emitting diodes (LEDs) according to an example embodiment. At step 1302, a single stage DC-DC converter with multiple output channels is used, the converter comprising one set of switches on a primary side of the converter, a rectifier and voltage multiplier component at the secondary side. At step 1304, the respective switches on the primary side of the converter are controlled for controlling an output current in the multiple output channels for dimming.

The method may comprise non-resonant operation of the converter.

The method may comprise receiving a first reference current signal and generating control pulses based on the reference current signal for controlling the respective switches on the primary side of the converter.

The method may comprise receiving the first reference current signal and a feedback current signal representative of the output current, and generating the control pulses based on the reference current signal and the feedback current signal for controlling the respective switches on the primary side of the converter. The method may comprise minimizing a difference between the first reference current signal and the feedback current signal through the generating of the control pulses. The method may comprise generating the control pulses based on a control signal from the PI or PID controller and a saw-tooth waveform. The method may comprise generating a zero-crossing signal by detecting zero-crossing in a primary current on the primary side of the converter and resetting a saw-tooth signal based on the zero-crossing signal to generate the saw-tooth waveform. The method may comprise peak current detection on the primary side of the converter to generate the saw-tooth waveform. The method may comprise using a voltage controlled oscillator (VCO) configured to generate the control pulses based on a control signal from the PI or PID controller.

The method may comprise open loop generation of the control pulses. The dimming component may comprise generate the control pulses based on the first reference signal using a voltage controlled oscillator (VCO).

The method may comprise pulse width modulation (PWM) of the control pulses. The method may comprise multiplexing the control pulses with a low frequency PWM waveform. The method may comprise minimizing a difference between a PWM reference current signal and a PWM feedback current signal representative of the output current in the multiple output channels through the PWM of the control pulses. The method may comprise PWM of the control pulses based on a control signal from the further PI or PID controller and a saw-tooth carrier signal.

The method may further comprise preventing a DC-offset current in the secondary side of the converter. The method may comprise using a DC blocking capacitors disposed in series with respective secondary side windings of a transformer of the converter. The method may comprise disposing each blocking capacitor such that a DC voltage equal to the DC-offset is applied across said each blocking capacitor in case an LED in the output channel coupled to said each blocking capacitor is shorted.

The method may comprise using a rectifier crowbar circuit disposed in each output channel for diverting current flow in said each output channel through a rectifier of the rectifier crowbar circuit in case of open failure of an LED in said each output channel.

The circuit may comprise using a Zener diode disposed in each output channel for diverting current flow in said each output channel through the Zener diode in case of open failure of an LED in said each output channel.

The method may comprise providing galvanic isolation between the primary and secondary sides.

Primary side devices of the converter may undergo zero voltage switching.

Secondary side output diodes of the converter may undergo zero current switching.

The method may comprise only capacitive filtering in each output channel.

The method may comprise operating the converter with global asymptotic stability for both CCR and PWM modes of dimming.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive. Also, the invention includes any combination of features, in particular any combination of features in the patent claims, even if the feature or combination of features is not explicitly specified in the patent claims or the present embodiments.

For example, while the described embodiments use galvanic isolation, in different embodiments without isolation e.g. a coupled inductor can be used in the converter.

1. A driver circuit for light emitting diodes (LEDs) comprising:
a single stage DC-DC converter with multiple output channels, the converter comprising one set of switches on a primary side of the converter, a rectifier and voltage multiplier component at the secondary side; and
a dimming control component configured to control the respective switches on the primary side of the converter for controlling an output current in the multiple output channels.

2. The circuit as claimed in claim 1, wherein the converter is configured for non-resonant operation.

3. The circuit as claimed in claim 1, wherein the dimming component is configured to receive a first reference current signal and to generate control pulses based on the reference current signal for controlling the respective switches on the primary side of the converter.

4. The circuit as claimed in claim 1, wherein the dimming component is configured to receive the first reference current signal and a feedback current signal representative of the output current, and to generate the control pulses based on the reference current signal and the feedback current signal for controlling the respective switches on the primary side of the converter.

5. (canceled)

6. (canceled)

7. (canceled)

8. (canceled)

9. (canceled)

10. The circuit as claimed in claim 1, wherein the dimming component is configured for open loop generation of the control pulses.

11. (canceled)

12. (canceled)

13. (canceled)

14. (canceled)

15. (canceled)

16. The circuit as claimed in claim 1, further comprising a component configured for preventing a DC-offset current in the secondary side of the converter.

17. (canceled)

18. (canceled)

19. The circuit as claimed in claim 1, comprising a rectifier crowbar circuit disposed in each output channel for diverting current flow in said each output channel through a rectifier of the rectifier crowbar circuit in case of open failure of an LED in said each output channel.

20. (canceled)

21. The circuit as claimed in claim 1, comprising a Zener diode disposed in each output channel for diverting current flow in said each output channel through the Zener diode in case of open failure of an LED in said each output channel.

22. The circuit as claimed in claim 1, wherein a galvanic isolation is provided between the primary and secondary sides of the converter, or wherein primary side devices of the converter undergo zero voltage switching.

23. (canceled)

24. The circuit as claimed in claim 1, wherein secondary side output diodes of the converter undergo zero current switching, or wherein a filter at each output channel comprises only a capacitive filter, or wherein the converter operates with global asymptotic stability for both CCR and PWM modes of dimming.

25. (canceled)

26. (canceled)

27. A driving method for light emitting diodes (LEDs), the method comprising:
using a single stage DC-DC converter with multiple output channels, the converter comprising one set of switches on a primary side of the converter, a rectifier and voltage multiplier component at the secondary side; and
controlling the respective switches on the primary side of the converter for controlling an output current in the multiple output channels for dimming.

28. The method as claimed in claim 27, comprising non-resonant operation of the converter.

29. The method as claimed in claim 27, comprising receiving a first reference current signal and generating control pulses based on the reference current signal for controlling the respective switches on the primary side of the converter.

30. The method as claimed in claim 27, comprising receiving the first reference current signal and a feedback current signal representative of the output current, and generating the control pulses based on the reference current signal and the feedback current signal for controlling the respective switches on the primary side of the converter.

31. (canceled)

32. (canceled)

33. (canceled)

34. (canceled)

35. (canceled)

36. The method as claimed in claim 27, comprising open loop generation of the control pulses.

37. (canceled)

38. (canceled)

39. (canceled)

40. (canceled)

41. (canceled)

42. (canceled)

43. (canceled)

44. (canceled)

45. The method as claimed in claim 27, comprising using a rectifier crowbar circuit disposed in each output channel for diverting current flow in said each output channel through a rectifier of the rectifier crowbar circuit in case of open failure of an LED in said each output channel.

46. The method as claimed in claim 27, comprising using a Zener diode disposed in each output channel for diverting current flow in said each output channel through the Zener diode in case of open failure of an LED in said each output channel.

47. The method as claimed in claim 27, comprising providing galvanic isolation between the primary and secondary sides, or wherein primary side devices of the converter undergo zero voltage switching.

48. (canceled)

49. The method as claimed in claim 27, wherein secondary side output diodes of the converter undergo zero current switching, or comprising only capacitive filtering in each output channel, or comprising operating the converter with global asymptotic stability for both CCR and PWM modes of dimming.

50. (canceled)

51. (canceled)
